(19) United States
(12) Patent Application Publication
(10) Pub. No.: US 2003/0132038 A1
(43) Pub. Date: Jul. 17, 2003

(54) Lift truck

(76) Inventors: Philip Thomas Callan, Droitwich Spa (GB); Peter Wooldridge, Much Wenlock (GB)

Correspondence Address: LISA A. BONGIOVI, 55 Griffin South Road, Bloomfield, CT, 06002, US

(21) Appl. No.: 10/342,667

(22) Filed: Jan. 14, 2003

(30) Foreign Application Priority Data
Jan. 15, 2002 (GB) 0200750.8

(51) Int. Cl. B62D 11/02

(52) U.S. Cl. 180/6.24

(57) ABSTRACT

A lift truck has front and rear sections pivotally connected for the front section to turn 90° to the rear section from the straight ahead state of the truck. The front and rear sections can each have a pair of wheels or one section can have a pair of wheels and the other section only a single wheel. All the wheels are drivable. In one aspect drive to a wheel is in proportion to the degree of articulation between the front and rear sections. In a second aspect drive to a wheel is controlled when said articulation exceeds a predetermined value, and in a third aspect a rear wheel or one or both of a pair of rear wheels can be undriven, i.e. freely rotatable in either direction of rotation.

This invention relates to a lift truck, particularly an articulated lift truck having a pair of lifting forks.

Articulated forklift trucks are commonly used in warehouses, as the articulated design thereof allows them to operate in narrower aisles than conventional non-articulated forklift trucks. Articulated trucks comprise a front section, carrying the lifting forks, pivotally connected at a vertical axis to a rear section. This articulation allows the front section, and the load carried by the forks, to rotate relative to the rear section and allows entry of the front section into storage bays.

However a problem can arise when tractive power is applied to both rear wheels of the truck when the front section is rotated through angles approaching 90°. The line of application of the drive causes the front wheels to skid sidewardly relative to their normal direction of travel. This leads to increased tyre wear and a loss of the fine steering control required for accurate load placement.

To try to overcome this problem, it is known to drive the two front wheels only, and to incorporate an arrangement allowing differential speeds of rotation. However, this can lead to a reduction of tractive effort, as the greater weight is located at the rear of the truck, and this can lead to difficulties when working on steep inclines.

An object of the invention is to provide a lift truck in an improved form, where the above problems are at least reduced.

According to a first aspect of the invention, there is provided a lift truck comprising a front section having a load carrier, a rear section, the front and rear sections being pivotally connected together so that the front section can be turned through 90° or substantially 90° either side of a straight ahead position, relative to the rear section, one of the front and rear sections having at least one wheel and the other of the front and rear sections having at least two wheels, with all of said wheels being drivable, characterised by means to control the drive to a selected wheel or selected wheels in proportion to the degree of articulation between the front and rear sections.

According to a second aspect of the invention, there is provided a lift truck, comprising a front section having a load carrier, a rear section, the front and rear sections being pivotally connected together so that the front section can be turned through 90° or substantially 90° either side of a straight ahead position, relative to the rear section, one of the front and rear sections having at least one wheel and the other of the front and rear sections having at least two wheels, with all of said wheels being drivable, characterised by means to control the drive to a selected wheel or selected wheels when the degree of articulation between the front and rear sections exceeds a predetermined value.

Typically the predetermined value corresponds to a steering angle of 45° or just less than 45°.

According to a third aspect of the invention, there is provided a lift truck comprising a front section having a load carrier, a rear section, the front and rear sections being pivotally connected together so that the front section can be turned through 90° or substantially 90° either side of a straight ahead position, relative to the rear section, one of the front and rear sections having at least one wheel and the other of the front and rear sections having at least two wheels, with all of said wheels being drivable, characterised by means allowing the wheel, or at least one of the wheels of the rear section to be undriven, in use.

The first aspect of the invention allows for an infinitely adjustable drive, i.e. the drive to the truck can automatically reduce down as the front section turns from said straight ahead position towards said 90° turned position. The control means of the first and second aspects of the invention can be microswitches. With the third aspect of the invention, drive to a wheel to be undriven can be disconnected by a differential unit or a declutching mechanism.

The invention also relates to respective methods of operating a lift truck according to said three aspects of the invention.

The invention will now be described, by way of example, with reference to the accompanying drawings, in which:

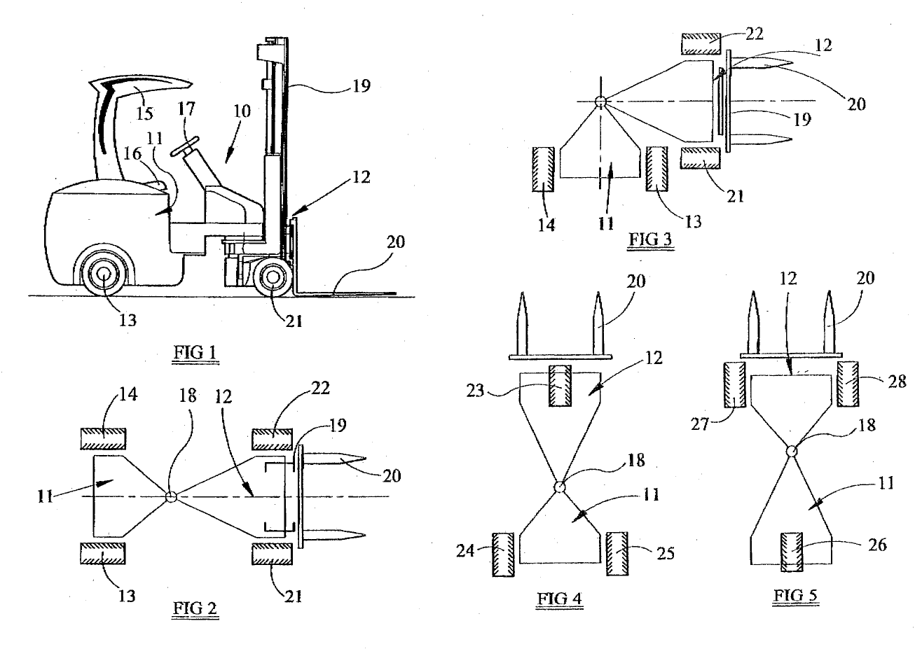

FIG. 1 is a side view of a lift truck of the invention,

FIG. 2 is a schematic, diagrammatic view showing the truck in a straight ahead position, with the front and rear sections in line,

FIG. 3 is a view like FIG. 2, but with the front section turned through 90° to the rear section,

FIG. 4 is a view like FIG. 2, but showing the front section having a single wheel, and

FIG. 5 is a view like FIG. 2, but showing the rear section having a single wheel.

With reference to FIG. 1, there is shown a lift truck 10 comprising a body or rear section 11 and a front section 12 in the form of a lifting device. The structure of the lift truck 10 is conventional, and itself forms no part of the present invention. The rear section 11 comprises a pair of rear wheels 13, 14, a cab 15 having a seat 16, a steering control 17 and pedals, such as a foot operated speed control, and other controls (not shown) for driving the trick and operating the lifting device, including moving this relative to the rear section 11 as will be described. The rear section 11 includes drive means for the truck, this conventionally being in the form of battery power, but it could alternatively be an I.C.E.

The front section 12 is pivotally connected at the forwardmost part of the rear section 1 by means of a conventional form of vertical pivot 18. This articulation between the front and rear sections of the lift truck enables the front section 12 to be turned angularly about its pivot relative to the rear section 11, for example as shown in FIG. 3, where this section is at 90° to the rear section 11. Any convenient means can be provided to effect this angular movement of the section 12, for example suitable gearing, a chain and sprocket arrangement or the like, with power being taken from the power supply in the rear section 11 previously described.

In the embodiment described, it can be seen that the front section 12 has a conventional upright mast 19 on which is carried a lifting device in the form of a pair of lifting forks 20 for movement up and down the mast. If required, the mast can be of known telescopic form. At the underside of the front section 12, positioned, in this embodiment, substantially in line with and at respective opposite sides of the mast are a pair of spaced front wheels 21,22.

The lift truck so far described is of conventional form. However the manner in which the various wheels of the lift truck are driven forms the subject of the invention, and as a consequence, as will be appreciated from the description of the invention set out below, each wheel can be mounted on its own respective individual axis in one embodiment, whilst in another embodiment a pair of wheels may be on a common axis.

As far as the driving of the wheels is concerned, it is to be noted that the lift truck has all wheel drive. In other words, it is possible to operate the lift truck with all wheels being driven. In one embodiment the battery or other motive power of the lift truck can be arranged to drive four separate electric or hydraulic motors associated with the four wheels respectively. However as will now been described, the drives to the wheels can be modified as follows,

Firstly means can be provided to control the drive to a selected wheel or wheels in inverse proportion to the degree of articulation between the front and rear sections. This can provide for an infinitely adjustable drive. Thus it will be possible for the speed of the truck automatically to reduce as the front section turns from its straight ahead position shown in FIG. 2 towards its 90° turned position shown in FIG. 3. It could be arranged that the reduction in drive and thus the reduction in the drive to the wheel could be applied only to the front wheels, only to the rear wheels, to all wheels, or to one of the front wheels, one of the rear wheels or to one of each. In each case the reduction in the drive would be proportionate to the degree of articulation between the two sections. Typically drive would be reduced to the inside rear wheel, with the front wheels continuing to be driven without any reduction in drive. However alternatively it could be arranged that the drive to the two front wheels automatically reduce more than the reduction in drive to the rear wheels as the front section is turned. In other embodiments the front section or alternatively the rear section could have only a single wheel, as will be described. Although typically the front section would tarn at a maximum of 90° to the rear section, this angle could be greater or less in still further embodiments.

In a second aspect of the invention, means are again provided for controlling drive to the wheels, but here the control means are only effective when the steering angle exceeds a predetermined value, ie. when the degree of articulation between the front and rear sections of the lift truck exceeds a predetermined angle. Thus here there need not be any proportional alteration in the drive, and moreover the control of the drive to one or more selected wheels only commences when the front section has pivoted through a predetermined angle relative to the rear section.

Thus with reference to FIGS. 2 and 3, maximum traction in the straight-ahead position is gained by driving all four wheels. This reduces the torque applied to each wheel and reduces the tendency to lose grip. The present dichotomy is that whilst four wheel drive is good for the lift truck when travelling up steep inclines, it is bad for manoeuvring the truck into narrow aisles and the like. On the other hand front wheel drive only is good for manoeuvrability. Accordingly with reference to FIG. 3, when the front section 12 articulates to an angle at or just below 45°, the drive to the rear wheels 13,14 is removed/disengaged so that the rear wheels are no longer driven, so that the truck moves through its driven front wheels 21, 22 alone. This removes the tendency for the front wheels to skid sideways as a consequence of the continued forwards driving of the rear wheels. However in this embodiment it is not essential that one or both of the rear wheels becomes undriven, it being possible, alternatively, merely to reduce the drive to one or both of the rear wheels thereby to reduce its speed. Again it would be possible merely to reduce the speed of the inside rear wheel. It will also be appreciated that with this embodiment it would be possible to reduce the drive to one or both of the front wheels in addition to, or instead of, the reduction in drive to one or both of the rear wheels. However in contrast to said first aspect of the invention referred to above, the drive reductions need not be dependent upon the degree of turning of the front section 12 once the drive control means activate at said predetermined angle of turning of the front section. Here again the front section or alternatively the rear section could have only a single wheel, as described below.

FIGS. 4 and 5 show respective further embodiments of the lift truck of FIG. 1, and each can have applied thereto the invention of the first or second aspect referred to above. In FIG. 4 it is shown that the front section 12 has a single central drivable wheel 23, with the rear section having a spaced pair of drivable wheels 24,25 equivalent to the rear wheels 13,14 of the embodiment of the truck shown in FIGS. 1 to 3. Accordingly the above descriptions of the first and second aspects apply equally to the truck shown in FIG. 4, the only difference being that control of drive to the front section 12 must necessarily now be to the single wheel 23 rather than to one or both of the front wheels 21,22 of the previously described embodiment of lift truck.

Similarly the lift truck embodiment shown in FIG. 5 differs from the embodiment of FIGS. 1 to 3 in having a single central drivable wheel 26 at the rear section 11 with a pair of spaced drivable wheels 27,28 at the front section 12, corresponding to the front wheels 21,22 of the first embodiment described in FIGS. 1 to 3. Thus again similarly whilst the first and second aspects of the invention described above can be applied to this embodiment of FIG. 5, it will be understood that reference to control of the drive to the rear section 11 will now necessarily be restricted to control of the single wheel 26 rather than to one or both of the rear wheels 13,14 of the lift truck of the first embodiment.

A third aspect of the invention relates to the lift truck shown in FIG. 1, 4 or 5 having means allowing the single rear wheel of the embodiment of FIG. 5 or at least one of the rear wheels of the other two embodiments to be undriven, in use. Accordingly it will be seen that this aspect differs from the first and second aspects of the invention described above, in that the control of the rear wheel or wheels is not dependent upon the degree of articulation between the front and rear sections, either proportionately or beyond a predetermined value. Accordingly with the embodiments of FIGS. 1 to 3 and FIG. 4 respectively, it is possible for any degree of articulation to have one or both of the wheels 13,14 or 24,25 undriven, even though the truck is still of all wheel drive design. Accordingly, particularly when the front section is being turned and manoeuvred into a narrow aisle, one of the rear wheels, or both, can have drive removed therefrom so that they merely become undriven and freely rotatable, backwards or forwards, in response to the drive applied to one or both of the front wheels. The removal/disconnection of drive to a rear wheel or to both thereof, can be effected by means of a differential unit or alternatively by the use of a declutching mechanism or respective declutching mechanisms associated with the two wheels. It will be appreciated that it is not essential that the effect of each rear wheel is the same, so that, for example, it would be possible to have the wheel 13 or 25 undriven for a time before removing drive from the other rear wheel 14,24 and alternatively in another embodiment, one of the rear wheels could be driven again after having been in an undriven state. It will thus be appreciated that very many variations and combinations of driven and undriven states are possible for these two rear wheels.

As far as the embodiment of FIG. 5 is concerned, it will be appreciated that the single rear wheel 26 can be undriven by removal of drive thereto at any suitable relative position of the front section relative to the rear section of the lift truck and that, moreover, in another embodiment, it could be ‘switched’ between driven and undriven states during turning of the front section 12, as appropriate. Again some form of differential or a declutching mechanism could be used to place the wheel 26 in an undriven state. A respective electric or hydraulic motor could be associated with each wheel to drive it when the motor is energised.

It will be understood that this third aspect of the invention differs from known prior art devices where means for controlling the driving of the rear wheels are provided, but the truck is not of all wheel drive form. With this third aspect, the method of operating the truck, in use, is also considered novel and inventive, for example in one embodiment, switching drive on and off to a rear wheel, or switching drive between a pair of rear wheels.

1. A lift truck comprising a front section having a load carrier, a rear section, the front and rear sections being pivotally connected together so that the front section can be turned through 90° or substantially 90° either side of a straight ahead position, relative to the rear section, one of the front and rear sections having at least one wheel and the other of the front and rear sections having at least two wheels, with all the wheels being drivable, characterised by the drive being controlled to a selected wheel or selected wheels in proportion to the degree of articulation between the front and rear sections.

2. A lift truck as claimed in claim 1, wherein the drive to the truck reduces, in use, as the front section turns from its straight ahead position.

3. A lift truck as claimed in claim 2, wherein the reduction in drive is effected by reducing the drive only to the or each front wheel.

4. A lift truck as claimed in claim 2, wherein the reduction in drive is effected by reducing the drive only to the or each rear wheel.

5. A lift truck as claimed in claim 2, wherein the reduction in drive is effected by reducing the drive to all the wheels of the lift truck.

6. A lift truck as claimed in claim 2, having a pair of front wheels, and wherein the reduction in drive is effected by reducing the drive to one of said front wheels.

7. A lift truck as claimed in claim 2, having a pair of rear wheels, and wherein the reduction in drive is effected by reducing the drive to one of said rear wheels.

8. A lift truck as claimed in claim 2, wherein the reduction in drive is effected by reducing the drive to at least one front wheel and at least one rear wheel.

9. A lift truck as claimed in claim 7, wherein drive is reduced to the inside rear wheel.

10. A lift truck as claimed in claim 9, having a pair of front wheels to which no reduction in drive is effected.

11. A lift truck as claimed in claim 2, wherein the drive to the or each front wheel automatically reduces more than the reduction in drive to the or each rear wheel as the front section turns, in use, from its straight ahead position.

12. A lift truck comprising a front section having a load carrier, a rear section, the front and rear sections being pivotally connected together so that the front section can be turned through 90° or substantially 90° either side of a straight ahead position, relative to the rear section, one of the front and rear sections having at least one wheel and the other of the front and rear sections having at least two wheels, with all of said wheels being drivable, characterised by the drive being controlled to a selected wheel or selected wheels when the degree of articulation between the front and rear sections exceeds a predetermined value.

13. A lift truck as claimed in claim 12, wherein the drive to a selected wheel or wheels is controlled so as to reduce. The speed of the truck when said predetermined angle is exceeded.

14. A lift truck as claimed in claim 13, wherein the reduction in drive is effected by reducing the drive only to the or each front wheel.

15. A lift truck as claimed in claim 13, wherein the reduction in drive is effected by reducing the drive only to the or each rear wheel.

16. A lift truck as claimed in claim 13, wherein the reduction in drive is effected by reducing the drive to all the wheels of the lift truck.

17. A lift truck as claimed in claim 13, having a pair of front wheels, and wherein the reduction in drive is effected by reducing the drive to one of said front wheels.

18. A lift truck as claimed in claim 13, having a pair of rear wheels, and wherein the reduction in drive is effected by reducing the drive to one of said rear wheels.

19. A lift truck as claimed in claim 13, wherein the reduction in drive is effected by reducing the drive to at least one front wheel and at least one rear wheel.

20. A lift truck as claimed in claim 18, wherein drive is reduced to the inside rear wheel.

21. A lift truck as claimed in claim 20, having a pair of front wheels to which no reduction in drive is effected.

22. A lift truck as claimed in claim 13, wherein the drive to the or each front wheel automatically reduces more than the reduction in drive to the or each rear wheel as the front section turns beyond said predetermined value.

23. A lift truck as claimed in claim 12, wherein the predetermined value corresponds to a steering angle of 45° or just less than 45°.

24. A lift truck comprising a front section having a load carrier, a rear section, the front and rear sections being pivotally connected together so that the front section can be turned through 90° or substantially 90°° either side of a straight ahead position, relative to the rear section, one of the front and rear sections having at least one wheel and the other of the front and rear sections having at least two wheels, with all of said wheels being drivable, characterised by the wheel, or at least one of the wheels, of the rear section being arranged to be undriven, in use.

25. A lift truck as claimed in claim 24, having a single rear wheel and a pair of front wheels.

26. A lift truck as claimed in claim 24, having a pair of rear wheels and a single front wheel.

27. A lift truck as claimed in claim 24, having a pair of front wheels and a pair of rear wheels.

28. A lift truck as claimed in either claim 26 or claim 27, wherein one only of the rear wheels can be undriven.

29. A lift truck as claimed in claim 24, wherein the or each undriven rear wheel is freely rotatable by means of a differential unit.

30. A lift truck as claimed in claim 24, wherein the or each undriven rear wheel is freely rotatable by means of a declutching mechanism.

31. A lift truck as claimed in claim 1, or claim 12, or claim 24, having a respective motor associated with each wheel so as to drive the wheel, in use, when the motor is energised.

32. A method of operating a lift truck as claimed in claim 24, comprising switching a rear wheel between driven and undriven states.

33. A method of operating a lift truck as claimed in claim 26 or claim 27, comprising removing the drive from one of the pair of rear wheels prior to removing the drive from the other rear wheel of the pair.
